(19) United States
(12) Patent Application Publication
(10) Pub. No.: US 2023/0004478 A1
(43) Pub. Date: Jan. 5, 2023

(54) SYSTEMS AND METHODS OF CONTINUOUS STACK TRACE COLLECTION TO MONITOR AN APPLICATION ON A SERVER AND RESOLVE AN APPLICATION INCIDENT

(71) Applicant: salesforce.com, inc., San Francisco, CA (US)

(72) Inventors: Ben Susman, Austin, TX (US); Christian Bayer, Cambridge, MA (US); Sergei Babovich, Burlington, MA (US); Sanyogita Sudhir Ranade, Woburn, MA (US); Saurabh Lodha, Burlington, MA (US); Timothy Cassidy, Burlington, MA (US); Krishnamurthy Muralidhar, Burlington, MA (US); Derek Forrest, Burlington, MA (US); Bing Xia, Burlington, MA (US); Kevin Fairfax, Burlington, MA (US)

(21) Appl. No.: 17/366,144

(22) Filed: Jul. 2, 2021

(51) Int. Cl. G06F 11/36; G06F 11/32; G06F 11/34; G06F 11/07

(52) U.S. Cl. CPC G06F 11/3636; G06F 11/323; G06F 11/3466; G06F 11/0787; G06F 2201/865

(57) ABSTRACT

Systems and methods are provided for performing, at a server, a stack trace of an application at a predetermined interval to generate a plurality of stack traces, where each stack trace of the plurality of stack traces is from a different point in time based on the predetermined interval. The stack trace is performed when the application is operating normally and when the application has had a failure. The plurality of stack traces stored are indexed by timestamp. The server may determine a state of the application based on at least one of the plurality of stack traces. The server may condense data for at least one of the plurality of stack traces that are indexed using predetermined failure scenarios for the application. The server may generate a report based on the condensed data and the state of the application, and may transmit the report for display.

### BACKGROUND

Typical stack tracing of an application that is executed by a server for the benefit of a set of users is performed after a time of failure. The stack tracing is performed in order to determine what caused the failure, and to address the point of failure. Besides stack tracing, applications can be monitored by Application Performance Managers (APMs). Such APMs typically monitor a set of performance metrics. Although the APMs collect performance data for the application, they are typically processing intensive, which generally inhibits the performance of the application that is relied upon by the users.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description explain the principles of implementations of the disclosed subject matter. No attempt is made to show structural details in more detail than can be necessary for a fundamental understanding of the disclosed subject matter and various ways in which it can be practiced.

FIGS. 1-3 show example methods of performing continuous stack trace collection to monitor an application and resolve application incidents according to implementations of the disclosed subject matter.

FIGS. 4A-4B show an example trace report according to implementations of the disclosed subject matter.

FIG. 5 shows an example system according to an implementation of the disclosed subject matter.

FIG. 6 shows an example hardware system that may implement the system shown in FIG. 5 according to an implementation of the disclosed subject matter.

### DETAILED DESCRIPTION

Various aspects or features of this disclosure are described with reference to the drawings, wherein like reference numerals are used to refer to like elements throughout. In this specification, numerous details are set forth in order to provide a thorough understanding of this disclosure. It should be understood, however, that certain aspects of disclosure can be practiced without these specific details, or with other methods, components, materials, or the like. In other instances, well-known structures and devices are shown in block diagram form to facilitate describing the subject disclosure.

Implementations of the disclosed subject matter perform stack traces of an application (e.g., a Java™ application) being executed by a server, both at time of failure and during normal operation. The stack traces may provide a status of an internal state of the application being executed by the server. Stack traces may be captured from the application at a predetermined interval (e.g., every minute) and may be indexed by timestamp and stored for analysis. The stored and indexed stack traces may be analyzed based on a selected time frame and target instance. A report may be generated that condenses the data of a plurality of individual stack traces to provide a status of the application for the selected time frame and target instance of the application. The generated report may include analysis of the stack traces based on predetermined failure scenarios to reduce manual analysis of the plurality of stack traces. Implementations of the disclosed subject matter may perform stack traces across clusters of application servers, and may generate a report which aggregates and/or condenses the cluster data. The generated data-reduced reports may be used to provide a faster time to resolve an incident with an application server and/or cluster of application servers.

Implementations of the disclosed subject matter improve upon current application performance management systems (APMs) that are typically used at a time of application failure, rather than continuously capturing a stack trace from an application at intervals. The APMs generate more data than the stack traces of the disclosed subject matter, which are captured at predetermined intervals. Moreover, stack traces generated by the implementations of the inventive concept are not as processing intensive as APMs, as the stack traces are generated from within the application server. That is, implementations of the disclosed subject matter may perform periodic stack traces that use less processing power of the server than APM systems, while having a high sampling frequency (i.e., many stack traces may be produced). In contrast, APM systems may only perform stack tracing when there is a problem with the application server, and thus may have a low sampling frequency. Moreover, implementations of the disclosed subject matter differ from typical stack tracing, which may be performed after a time of failure, rather than capturing stack traces at predetermined intervals during both normal operation and when the application is experiencing an error as with the disclosed subject matter.

Current APMs typically monitor two sets of performance metrics. The first set of performance metrics relates to the performance experienced by end users of the application (e.g., average response times under peak load), and the second set of performance metrics measures the computational resources used by the application for the load, indicating whether there is adequate capacity to support the load, as well as possible locations of a performance bottleneck. Measurement of these quantities establishes an empirical performance baseline for the application. The baseline can then be used to detect changes in performance. Changes in performance can be correlated with external events and subsequently used to predict future changes in application performance. Although the APMs collect performance data for the application, they typically do not perform stack traces during normal operation, as well as at the time of failure, as is done in the present disclosed subject matter. Some APMs are used to perform stack traces at a time of application failure, rather than continuously capturing a stack trace from an application at intervals. Also, typical APMs generate more data than the traces captured at predetermined intervals, as in the disclosed subject matter.

For example, an on-line shop application and/or other commerce application may be executed on a Java™ application server (i.e., where one or more servers may execute an application to serve application data to client devices). The on-line shop application may include a plurality of instances (e.g., tens of instances, hundreds of instances, thousands of instances, or the like) that may use an identical code base, but which may be customized to include custom code. Determining the internal state of an application server when it fails is typically difficult, and usually requires attaching a debugger to the instance. Because each application server instance may run identical code, their encountered failure scenarios may be similar, and may manifest themselves through similar stack traces (e.g., Java™ stack traces).

Implementations of the disclosed subject matter may determine a status of an application server both at time of failure, as well as during normal operation. Stack traces (e.g., Java™ stack traces) of applications may be performed at predetermined intervals (e.g., every minute, every five minutes, every ten minutes, every hour, or the like) and may index the traces by timestamp and store them for analysis. When performing an analysis of the stored stack traces, a time frame and/or a target instance of the application (e.g., when a plurality of instances may be executed by one or more servers) for which stack traces are to be analyzed may be selected. A report may be generated that condenses the data of individual stack traces into one or more failure scenarios.

The stack trace data may be compressed, and may be transferred to a storage device for storage at predetermined periodic intervals (e.g., every minute, every five minutes, every ten minutes, or the like). The stack trace data may be text data. Portions of the text may be repeated, where the server may compress the repeated portions. In some implementations, the stack trace data may be deleted from the storage device after a predetermined period of time (e.g., five days, seven days, two weeks, or the like). By performing stack traces and predetermined intervals and storing the stack traces in a storage device, baseline comparison data may be generated that may be used to determine the operational state and/or changing operational state of the server executing the application.

The stored data may be used to identify failure scenarios common across all application servers. For example, common failure scenarios may be with communication failures between the server and a third-party system over a communications network. In another example, the failure related to a failed communication between the server and a database. Other failure examples may include when the application is stuck in an endless loop, when the application is executing long-running requests, or the like. Another failure example may be when the server is executing custom code. The failure scenarios may be generalized for one or more applications that are executed by the server.

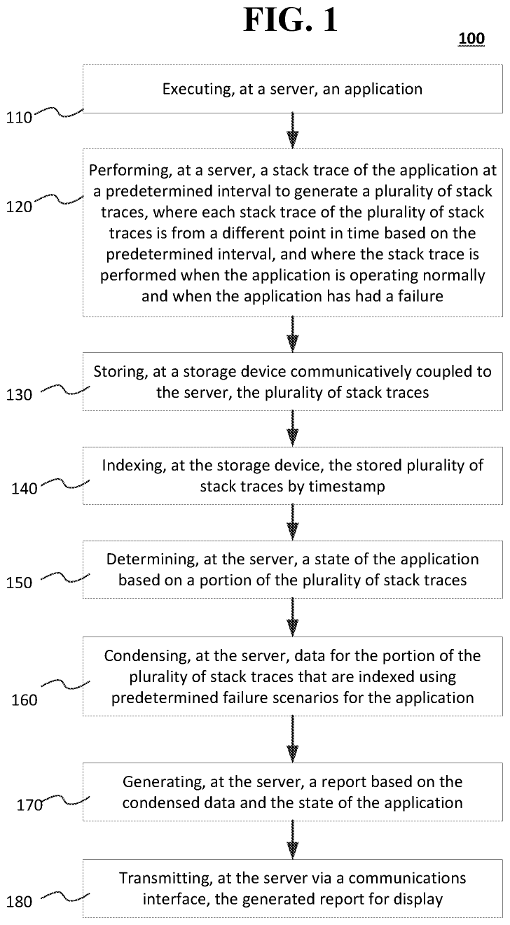

FIGS. 1-3 show an example method 100 of performing continuous stack trace collection to monitor an application and resolve application incidents according to implementations of the disclosed subject matter.

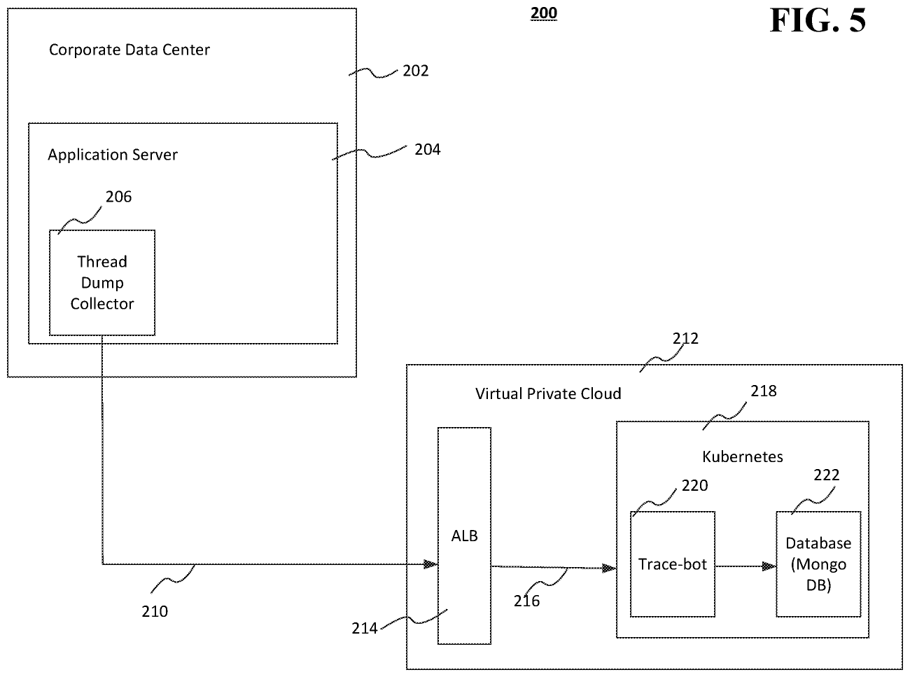

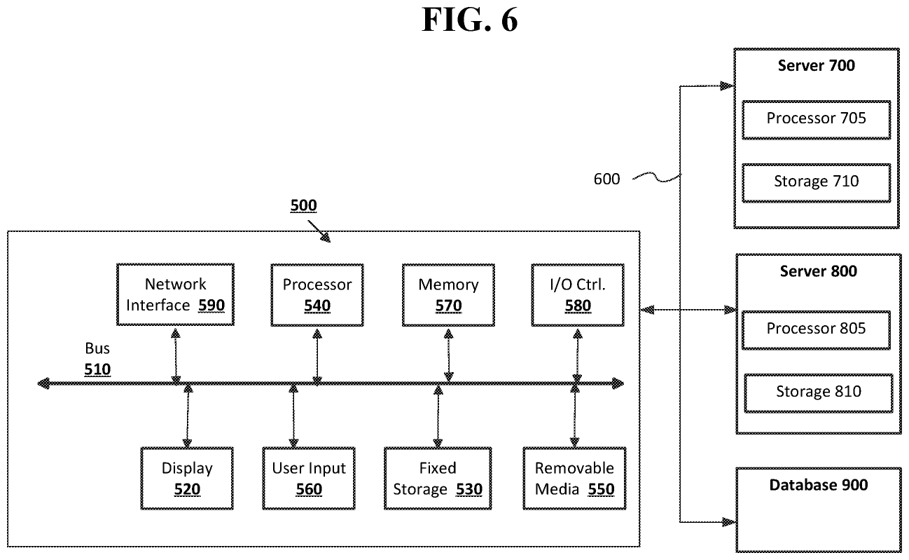

As shown in FIG. 1, method 100 may include executing an application at a server at operation 110. The server may be part of data center 202 shown in FIG. 5, where application server 204 may execute an application. The server of the data center 202 may be server 700 shown in FIG. 6, as discussed in detail below. The server may be one or more application servers that may execute one or more instances of the application for one or more user devices, such as computer 500 shown in FIG. 6. The server may have one or more processors (e.g., processor 705, 805 shown in FIG. 6) to execute the one or more application instances.

At operation 120, the server may perform a stack trace of the application at a predetermined interval to generate a plurality of stack traces. For example, the predetermined interval may be every minute, every five minutes, every ten minutes, or the like. Each stack trace of the plurality of stack traces may be from a different point in time based on the predetermined interval. The stack trace at operation 120 may be performed when the application is operating normally and/or when the application has had a failure. In one example, a communicative connection may be established between the application server 204 and a trace-bot 220 of the Kubernetes instance 218 as shown in FIG. 5. The application server 204 may generate stack traces, and may transmit them to the trace-bot 220. The trace-bot 220 may collect the traces of the application. That is, the traces of the application may be pushed to the trace-bot 220, which may collect the traces. In another example, stack traces (e.g., as part of operation 120 described above) for an application being executed on the server 700 and/or 800 as shown in FIG. 6 may be pushed to the trace-bot 220 for collection.

At operation 130, the server may store the plurality of stack traces in a storage device that may be communicatively coupled to the server. For example, stack traces generated by the application server 204 may be pushed and/or transmitted to trace-bot 220 of FIG. 5, and the traces that are collected by the trace-bot 220 may be stored in database 222. In another example, the stack traces may be stored in storage device 710 shown in FIG. 6 and/or at database 900, both of which may be communicatively coupled to server 700. The server may index the stored plurality of stack traces by timestamp at the storage device at operation 140. The indexed data may be stored in database 222 shown in FIG. 5, storage 710, 810 shown in FIG. 6, and/or database 900 shown in FIG. 6.

At operation 150, the server may determine a state of the application based on a portion of the plurality of stack traces (e.g., three stack traces, 10 stack traces, or the like). The server may determine whether the application is operating normally, or whether there is an error, such as a communications error, an endless loop of the application, a long-running request, and/or execution of custom code that has an error, or the like. For example, threads in the application server may be expected to run a maximum of a few hundred milliseconds. When such threads have not finished after a predetermined period of time (e.g., less than 10 seconds), the server may determine that there is an error and that the application is not operating normally.

At operation 160, the server may condense data for the portion of the plurality of stack traces that are indexed using predetermined failure scenarios for the application. The stack trace data may be text data that may include repeated portions. The predetermined failure scenarios may include, for example, communication between the server and a third-party system via a communications network, communication between the server a database via the communications network, an endless loop of the application, a long-running request of the application, and/or execution of custom code of the application at the server, or the like. The server may condense the data by correlating threads of the portion of the plurality of stack traces based on processor consumption per each thread. The processor consumption may be the active use and/or a percentage of active use of the processor of the server (e.g., the processor of the application server 204 of the data center 202 of FIG. 5, and/or the processor of the server 700 of FIG. 6). In some implementations, the server may condense the data by removing standard sections of the plurality of stack traces.

For example, the server may correlate threads from the stack trace with the processor consumption for each thread. The server may reduce the repeated data (e.g., “boilerplate” data) that may be a part of stack traces, but may not be useful in determining the status of an application executed by a server.

The server may classify the stack traces (e.g., the interesting stack traces) and group together stack traces with similar and/or identical text, but with different context (i.e., from a different thread). By classifying and grouping the stack traces, the server may generate a report to show what thread in the application server is doing the same thing, such as waiting for an external web service or database to return data, or the like.

In some implementations, the server may condense the data at operation 160 by grouping together stack traces based on stack traces having identical text but different contexts, and/or stack traces having identical text and the same context. The server may group together stack traces with similar and/or identical text and context (i.e., taken from a different stack trace snapshot). The threads may span multiple snapshots, but still have identical context and stack trace contents. That is, such threads may be likely to be ‘stuck’ and not moving forward (i.e., so-called ‘long-running’ threads). The generated report may include the grouped stack traces.

The server may pattern-match stack traces against a predetermined set of error scenarios, and may classify such stack traces that match the pattern as having an error and/or failure.

The stack traces may be pattern matched against a set of predetermined tasks and/or interactions (which may not necessarily be error conditions). The server may sum each category of pattern matched traces. This may be used to generate a report to show how many application server threads are doing the same thing (e.g., network input/output, communicating with the database, running custom code, or the like). The generated report may assist a user and/or administrator in determining if one or more subsystems appears to be slow and blocking one or more threads. For example, the response of the database that may be less than a predetermined threshold may be shown in different stack traces, and may include similar blocks across threads. The generated report may present the grouped stack traces, which may summarize the issues with the application. In some implementations, the generated report may show processor consumption of each stack trace.

In implementations of the disclosed subject matter, the server may monitor instances of the application, and capture stack traces at predetermined intervals. Stack trace data may be sent to a central aggregator instance of the server that may also provide a user interface (e.g., a graphical user interface (GUI)) for generated reports. The central aggregator at the server may store stack trace data at a storage device and/or database, and may accept inbound connections that include stack trace data. The central aggregator may accept inbound connections containing other runtime instance data, such as job completion data, feature toggle data, database object churn data, and the like. Such runtime instance data may be stored in the storage device and/or database communicatively coupled to the server.

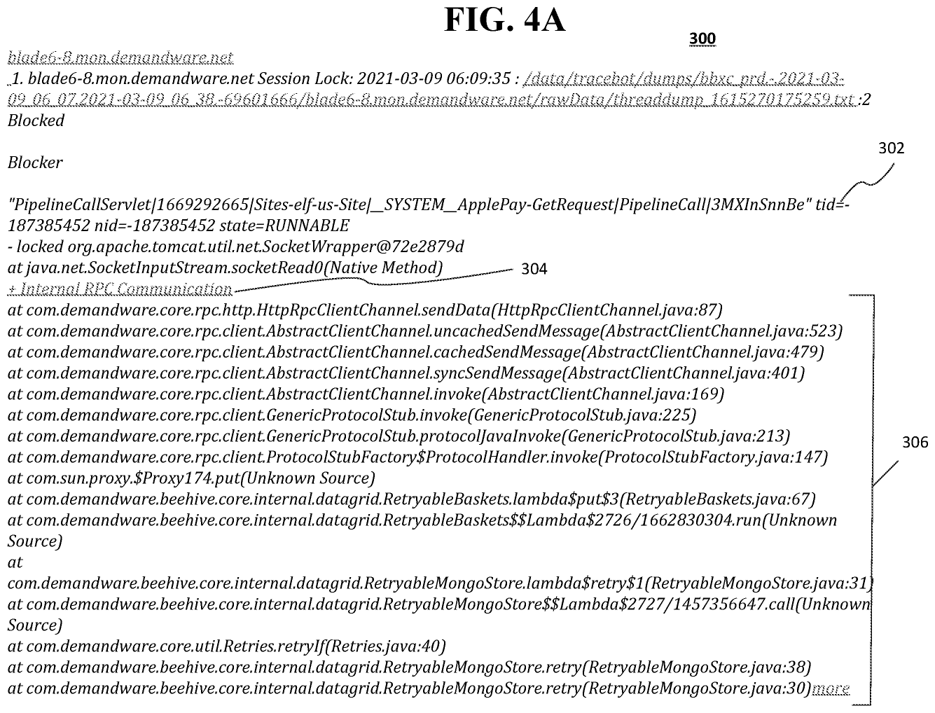

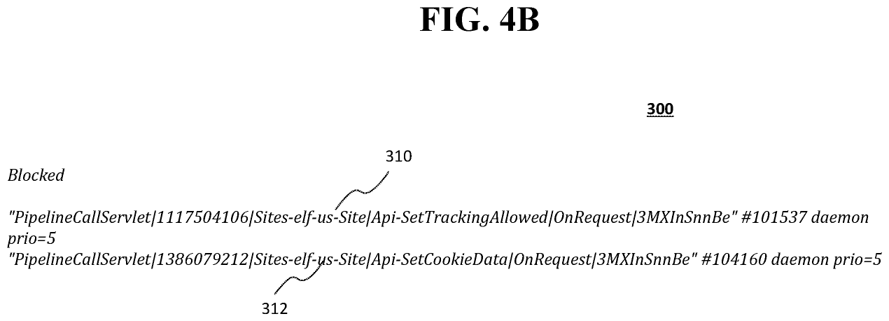

In some implementations of the disclosed subject matter, the stack trace text may be considered without context (e.g., without operating system metadata), and the stack trace text may be compared to one or more other stack traces. The server may group together stack traces, such as identical stack traces, to be presented in the report. In some implementations, the server may collapse, condense, and/or remove sections of the stack trace that may not include information that relates to the operational status of the application. For example, such sections may include boilerplate library stack trace information that may be repeated. By collapsing, condensing, and/or removing this repeated or information (e.g., as shown by the collapsing of Internal RPC Communication 304 in FIG. 4A), the report may include information that relates to the operational status of the application. In some implementations of the disclosed subject matter, the server may determine the lines from the stack trace that may be considered boilerplate by performing filtering, statistical analysis, natural language processing, or the like. For example, the server may determine specific patterns within the stack trace text, based on domain specific and/or expert system data. The server may collapse, condense, and/or remove text from the stack trace based on filtering, where the filtering may be based on message size or the like. As described above, the server may collect baseline stack trace data and count occurrences of each line across application server instances and/or specific to application server instances to determine a frequency ‘score’ for each line. If an average of normalized frequency scores exceeds a predetermined threshold, the server may select the stack trace (e.g., as being an “interesting” stack trace for the report), and may use at least a portion of the stack trace in the when generating the report.

The server may generate a report based on the condensed data and the state of the application at operation 170. For example, the trace-bot 220 of instance 218 of FIG. 5 may request stack trace data from the database 222 of the virtual private cloud 212 for a particular time period, application instance, and the like. The trace-bot 220 of instance 218 may generate a report based on the received stack trace data, and other related data (e.g., operating system metadata, and the like). The server may transmit, via a communications interface, the generated report for display. In another example, as shown in FIG. 6, the server 700 may transmit the generated report to computer 500, which may display the generated report on display 520. In another example, the server (e.g., server 700 and/or 800 shown in FIG. 6) may receive a request (e.g., via communication network 600 shown in FIG. 6) from a user device (e.g., computer 500 shown in FIG. 6) for a report on the status of the application. The request may include, for example, the dates and/or times for the stack traces, the customer instance, the number of stack traces to consider, and the like. Based on the request, the server may generate a report for display on the user device (e.g., display 520 of computer 500) that may include analysis of, for example, long running threads, customer-created code with errors (e.g., endless loops), customer-created code links to hosting customer instance, processor consumption for each identified issue thread, third party communication threads, database interaction threads, and the like.

Display 300 shown in FIGS. 4A-4B show an example report generated based on a received request, where the display is generated using the method 100 shown in FIGS. 1-3 and described throughout. The display 300 includes user threads 310 and 312 (“PipelineCallServlet|1117504106|Sites-elf-us-Site|Api-SetTrackingAllowed|OnRequest|3MXInSnnBe″ #101537 daemon prio=5” shown as thread 310 and “PipelineCallServlet|1386079212|Sites-elf-us-Site|Api-SetCookieData|OnRequest|3MXInSnnBe″ #104160 daemon prio=5” shown as thread 312) are being held up by a Blocker thread 302 (“PipelineCallServlet|1669292665|Sites-elf-us-Site|_SYSTEM_ApplePay-GetRequest|PipelineCall|3MXInSnnBe” tid=-187385452 nid=-187385452 state=RUNNABLE). As described above, the server may collapse blocks of code that are determined to be boilerplate code (e.g., Internal RPC Communication 304), and may reduce the output trace text 306 to a size that may be reviewed by a user and/or operator.

When generating the report, the server may process the stack traces for the user-supplied time frame. For each unique stack trace, the server may build an internal representation for similar stack traces. That is, the representation may add context information that regular stack traces may not have. For example, operating system metadata (e.g., processor consumption) of the stack traces may be used by the server in generating the report. The metadata may be assigned to one or more stack traces based on their process identifier. The metadata may be used to determine and/or identify threads with processor consumption that is greater than a predetermined amount. The operating system metadata and/or the stack trace data may be used in generating a report to show the status of the application at a particular point in time.

In some implementations, method 100 may include an operation of having the server delete, at the storage device, at least one of the plurality of stack traces after it has been stored for a predetermined period of time. That is, stack traces that may be no longer useful for analysis of the operating state of the application or instances of the application may be deleted after a predetermined period of time.

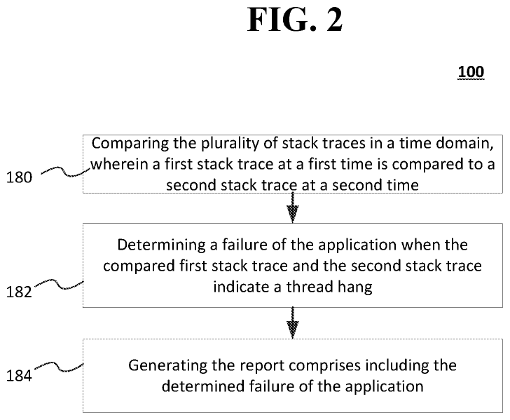

FIG. 2 shows optional operations that may be performed as part of method 100 according to implementations of the disclosed subject matter. At operation 180, the server may compare the plurality of stack traces in a time domain. The server may compare a first stack trace at a first time to a second stack trace at a second time. For example, a server may compare a stack trace from a first time (e.g., a minute ago) with a current stack trace to determine whether there is a thread that “hangs” (i.e., is not operating normally, and is causing delay). That is, implementations of the disclosed subject matter may identify long running and potentially stuck work threads that hang, as the time to complete these requests may be greater than a predetermined period of time (e.g., less than one second).

At operation 182, the server may determine a failure and/or error of the application when the compared first stack trace and the second stack trace indicate a thread hang. At operation 184, the report generated at operation 170 shown in FIG. 7, may be modified and/or adjusted based on the error and/or failure of the application determined at operation 182.

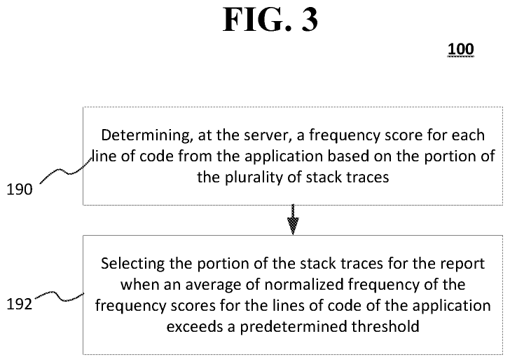

FIG. 3 shows optional operations that may be performed as part of method 100 according to implementations of the disclosed subject matter. At operation 190, the server may determine a frequency score for each line of code from the application based on a portion of the plurality of stack traces. At operation 192, the server may select the portion of the stack traces for the report when an average of normalized frequency of the frequency scores for the lines of code of the application exceeds a predetermined threshold.

That is, the server may identify segments of stack traces of interest for analysis by pruning other portions of stack trace data. For example, the server may use statistical methods, and/or may determine repeated sections, or the like, when determining which portions of the stack trace data to prune.

In implementations of the disclosed subject matter, a server may collect stack trace data (e.g., using the thread dump collector 206 from the trace-bot 220 shown in FIG. 5), and determine the number of occurrences of each line of code across application server instances and/or determine the number of occurrences of each line of code that is specific to application server instances. As described above, the server may determine a frequency ‘score’ for each line of code. If an average of normalized frequency scores exceeds a predetermined threshold, the server may select the stack trace as “interesting,” and may use at least a portion of the stack trace in the when generating the report.

FIG. 5 shows example system 200 that may perform the operations discussed above in connection with FIGS. 1-3 according to an implementation of the disclosed subject matter. Data center 202 may include one or more application servers 204, which may include a thread dump collector 206. The application server 204 may transmit a request for a stack trace to the virtual private cloud 212 via communications network 210. The virtual private cloud 212 may include an application load balancer (ALB) 214, that may provide the trace request 216 to a Kubernetes instance 218. The ALB 214 manages incoming requests to the virtual private cloud 212. Kubernetes instance 218 may be a container-orchestration system for automating computer application deployment, scaling, and/or management. The Kubernetes instance 218 may include trace-bot 220 and a database 222 (e.g., which may be a Mongo database in Kubernetes). Stack trace data from periodic stack traces by trace-bot 220 may be stored in database 222. The trace-bot 220 may receive the stack traces of the application and generate reports described above in connection with method 100, shown in FIGS. 1-3.

Implementations of the presently disclosed subject matter may be implemented in and used with a variety of component and network architectures. FIG. 6 is an example computer 500 which may display application status reports generated by server 700 and/or 800 based on the example methods shown in FIGS. 1-3 and described above.

As shown in FIG. 6, the computer 500 may communicate with a server 700 (e.g., a server, cloud server, database, cluster, application server, neural network system, or the like) via a wired and/or wireless communications network 600. The server 700 may be a plurality of servers, cloud servers, databases, clusters, application servers, neural network systems, or the like. The server 700 may include a processor 705, which may be a hardware processor, a microprocessor, an integrated circuit, a field programmable gate array, or the like. The server 700 may include a storage device 710. The storage 710 may use any suitable combination of any suitable volatile and non-volatile physical storage mediums, including, for example, hard disk drives, solid state drives, optical media, flash memory, tape drives, registers, and random access memory, or the like, or any combination thereof. The server 700 may be communicatively coupled to database 900, which may use any suitable combination of any suitable volatile and non-volatile physical storage mediums, including, for example, hard disk drives, solid state drives, optical media, flash memory, tape drives, registers, and random access memory, or the like, or any combination thereof. The server 700 may be communicatively coupled to server 800, which may be one or more servers, cloud servers, databases, clusters, application servers, neural network systems, or the like. The server 800 may include a processor 805, which may be a hardware processor, a microprocessor, an integrated circuit, a field programmable gate array, or the like Server 800 may include storage 810, which may use any suitable combination of any suitable volatile and non-volatile physical storage mediums, including, for example, hard disk drives, solid state drives, optical media, flash memory, tape drives, registers, and random access memory, or the like, or any combination thereof. The server 800 may be a third-party server to provide data for an application being executed by server 700. The server 700 may use input from the database 900 and/or server 800 in dynamically generating a report on the status of the application.

In an example, the application server 204 of FIG. 5 may be server 700 of FIG. 6, and the virtual private cloud 212 of FIG. 5 may be server 800 of FIG. 6. The database 222 of FIG. 5 may be the database 900 of FIG. 6. The communications network 210 of FIG. 5 may be the communications network 600 shown in FIG. 6.

The storage 710 of the server 700, the storage 810 of the server 800, and/or the database 900, may store data, such as stack trace data, operating system metadata, and the like. Further, if the storage 710, storage 910, and/or database 800 is a multitenant system, the storage 710, storage 910, and/or database 800 can be organized into separate log structured merge trees for each instance of a database for a tenant. Alternatively, contents of all records on a particular server or system can be stored within a single log structured merge tree, in which case unique tenant identifiers associated with versions of records can be used to distinguish between data for each tenant as disclosed herein. More recent transactions can be stored at the highest or top level of the tree and older transactions can be stored at lower levels of the tree. Alternatively, the most recent transaction or version for each record (i.e., contents of each record) can be stored at the highest level of the tree and prior versions or prior transactions at lower levels of the tree.

The computer (e.g., user computer, enterprise computer, or the like) 500 may include a bus 510 which interconnects major components of the computer 500, such as a central processor 540, a memory 570 (typically RAM, but which can also include ROM, flash RAM, or the like), an input/output controller 580, a user display 520, such as a display or touch screen via a display adapter, a user input interface 560, which may include one or more controllers and associated user input or devices such as a keyboard, mouse, Wi-Fi/cellular radios, touchscreen, microphone/speakers and the like, and may be communicatively coupled to the I/O controller 580, fixed storage 530, such as a hard drive, flash storage, Fibre Channel network, SAN device, SCSI device, and the like, and a removable media component 550 operative to control and receive an optical disk, flash drive, and the like.

The bus 510 may enable data communication between the central processor 540 and the memory 570, which may include read-only memory (ROM) or flash memory (neither shown), and random access memory (RAM) (not shown), as previously noted. The RAM may include the main memory into which the operating system, development software, testing programs, and application programs are loaded. The ROM or flash memory can contain, among other code, the Basic Input-Output system (BIOS) which controls basic hardware operation such as the interaction with peripheral components. Applications resident with the computer 500 may be stored on and accessed via a computer readable medium, such as a hard disk drive (e.g., fixed storage 530), an optical drive, floppy disk, or other storage medium 550.

The fixed storage 530 can be integral with the computer 500 or can be separate and accessed through other interfaces. The fixed storage 530 may be part of a storage area network (SAN). A network interface 590 can provide a direct connection to a remote server via a telephone link, to the Internet via an internet service provider (ISP), or a direct connection to a remote server via a direct network link to the Internet via a POP (point of presence) or other technique. The network interface 590 can provide such connection using wireless techniques, including digital cellular telephone connection, Cellular Digital Packet Data (CDPD) connection, digital satellite data connection or the like. For example, the network interface 590 may enable the computer to communicate with other computers and/or storage devices via one or more local, wide-area, or other networks, such as communications network 600.

Many other devices or components (not shown) may be connected in a similar manner (e.g., data cache systems, application servers, communication network switches, firewall devices, authentication and/or authorization servers, computer and/or network security systems, and the like). Conversely, all the components shown in FIG. 6 need not be present to practice the present disclosure. The components can be interconnected in different ways from that shown. Code to implement the present disclosure can be stored in computer-readable storage media such as one or more of the memory 570, fixed storage 530, removable media 550, or on a remote storage location.

Some portions of the detailed description are presented in terms of diagrams or algorithms and symbolic representations of operations on data bits within a computer memory. These diagrams and algorithmic descriptions and representations are commonly used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

It should be borne in mind, however, that all these and similar terms are to be associated with the appropriate physical quantities and are merely convenient labels applied to these quantities. Unless specifically stated otherwise as apparent from the above discussion, it is appreciated that throughout the description, discussions utilizing terms such as “executing,” “performing,” “storing,” “indexing,” “determining,” “condensing,” “generating,” “transmitting,” “deleting,” “comparing,” “selecting,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

More generally, various implementations of the presently disclosed subject matter can include or be implemented in the form of computer-implemented processes and apparatuses for practicing those processes. Implementations also can be implemented in the form of a computer program product having computer program code containing instructions implemented in non-transitory and/or tangible media, such as hard drives, solid state drives, USB (universal serial bus) drives, CD-ROMs, or any other machine readable storage medium, wherein, when the computer program code is loaded into and executed by a computer, the computer becomes an apparatus for practicing implementations of the disclosed subject matter. Implementations also can be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium can be implemented by a general-purpose processor, which can transform the general-purpose processor or a device containing the general-purpose processor into a special-purpose device configured to implement or carry out the instructions. Implementations can be implemented using hardware that can include a processor, such as a general purpose microprocessor and/or an Application Specific Integrated Circuit (ASIC) that implements all or part of the techniques according to implementations of the disclosed subject matter in hardware and/or firmware. The processor can be coupled to memory, such as RAM, ROM, flash memory, a hard disk or any other device capable of storing electronic information. The memory can store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described to explain the principles of implementations of the disclosed subject matter and their practical applications, to thereby enable others skilled in the art to utilize those implementations as well as various implementations with various modifications as can be suited to the particular use contemplated.

1. A method comprising:
executing, at a server, an application;
performing, at a server, a stack trace of the application at a predetermined interval to generate a plurality of stack traces, wherein each stack trace of the plurality of stack traces is from a different point in time based on the predetermined interval, and wherein the stack trace is performed when the application is operating normally and when the application has had a failure;
storing, at a storage device communicatively coupled to the server, the plurality of stack traces;
indexing, at the storage device, the stored plurality of stack traces by timestamp;
determining, at the server, a state of the application based on a portion of the plurality of stack traces;
condensing, at the server, data for the portion of the plurality of stack traces that are indexed using predetermined failure scenarios for the application by removing repeated data from the portion of the plurality of stack traces;
generating, at the server, a report based on the condensed data and the state of the application; and
transmitting, at the server via a communications interface, the generated report for display.

2. The method of claim 1, further comprising stack trace data that is text data that includes repeated portions.

3. The method of claim 1, wherein at least one of the predetermined failure scenarios are selected from the group consisting of: communication between the server and a third-party system via a communications network; communication between the server a database via the communications network; an endless loop of the application; a request of the application that runs for a period of time; and execution of custom code of the application at the server.

4. The method of claim 1, wherein the data of at least one of the plurality of stack traces is text data and includes repeated sections.

5. The method of claim 1, further comprising:
deleting, at the storage device, at least one of the plurality of stack traces after it has been stored for a predetermined period of time.

6. The method of claim 1, wherein the condensing the data further comprises correlating threads of the portion of the plurality of stack traces based on processor consumption per each thread.

7. The method of claim 1, further comprising:
comparing the plurality of stack traces in a time domain, wherein a first stack trace at a first time is compared to a second stack trace at a second time; and
determining a failure of the application when the compared first stack trace and the second stack trace indicate a thread hang,
wherein the generating the report comprises the determined failure of the application.

8. The method of claim 1, further comprising:
determining, at the server, a frequency score for each line of code from the application based on the portion of the plurality of stack traces; and
selecting the portion of the stack traces for the report when an average of normalized frequency of the frequency scores for the lines of code of the application exceeds a predetermined threshold.

9. The method of claim 1, wherein condensing the data further comprises removing standard sections of the plurality of stack traces.

10. The method of claim 1, wherein the condensing the data further comprises grouping together stack traces based on at least one selected from the group consisting of: stack traces having identical text but different contexts, and stack traces having identical text and the same context,
wherein the generated report includes the grouped stack traces.

11. A system comprising:
a server comprising a processor coupled to a memory to:
execute an application;
perform a stack trace of the application at a predetermined interval to generate a plurality of stack traces, wherein each stack trace of the plurality of stack traces is from a different point in time based on the predetermined interval, and wherein the stack trace is performed when the application is operating normally and when the application has had a failure;
store, at a storage device communicatively coupled to the server, the plurality of stack traces;
index, at the storage device, the stored plurality of stack traces by timestamp;
determine a state of the application based on a portion of the plurality of stack traces;
condense data for the portion the plurality of stack traces that are indexed using predetermined failure scenarios for the application by removing repeated data from the portion of the plurality of stack traces;
generate a report based on the condensed data and the state of the application; and
transmit, via a communications interface coupled to the server, the generated report for display.

12. The system of claim 11, further comprising stack trace data that is text data that includes repeated portions.

13. The system of claim 11, wherein at least one of the predetermined failure scenarios are selected from the group consisting of: communication between the server and a third-party system via a communications network; communication between the server a database via the communications network; an endless loop of the application; a request of the application that runs for a period of time; and execution of custom code of the application at the server.

14. The system of claim 11, wherein the data of at least one of the plurality of stack traces is text data and includes repeated sections.

15. The system of claim 11, wherein the server deletes, at the storage device, at least one of the plurality of stack traces after it has been stored for a predetermined period of time.

16. The system of claim 11, wherein the condensing the data further comprises correlating threads of the portion of the plurality of stack traces based on processor consumption per each thread.

17. The system of claim 11, wherein the server compares the plurality of stack traces in a time domain, wherein a first stack trace at a first time is compared to a second stack trace at a second time,
wherein the server determines a failure of the application when the compared first stack trace and the second stack trace indicate a thread hang, and
wherein the generated report includes the determined failure of the application.

18. The system of claim 11, wherein the server determines a frequency score for each line of code from the application based on the portion of the plurality of stack traces, and selects the portion of the stack traces for the report when an average of normalized frequency of the frequency scores for the lines of code of the application exceeds a predetermined threshold.

19. The system of claim 11, wherein the server further condenses the data by removing standard sections of the plurality of stack traces.

20. The system of claim 11, wherein the server further condenses the data by grouping together stack traces based on at least one selected from the group consisting of: stack traces having identical text but different contexts, and stack traces having identical text and the same context, and
wherein the generated report includes the grouped stack traces.
